(19) United States
(12) Patent Application Publication
(10) Pub. No.: US 2026/0227507 A1
(43) Pub. Date: Aug. 6, 2026

(54) PROXIMITY SENSING KEYBOARD

(71) Applicant: Elliptic Laboratories ASA, Oslo (NO)

(72) Inventor: Erik FORSSTRÖM, Oslo (NO)

(73) Assignee: Elliptic Laboratories ASA, Oslo (NO)

(21) Appl. No.: 19/150,152

(22) PCT Filed: Feb. 7, 2024
(86) PCT No.: PCT/NO2024/050028

§ 371 Date: Jul. 22, 2025

(30) Foreign Application Priority Data
Feb. 13, 2023 (NO) 20230140

(51) Int. Cl. G01S 15/08; G01S 15/04; G06F 1/16; G06F 3/01

(52) U.S. Cl. CPC G01S 15/08; G01S 15/04; G06F 1/1662; G06F 3/017

(57) ABSTRACT

The present invention relates to a keyboard control system and method for operation. The system includes at least two ultrasound transducers positioned at a distance from each other in the keyboard, at least one of which being adapted to transmit ultrasound signals and at least one being adapted to receive ultrasound signals, and provide a measure of the distance to a reflecting object relative to the transducers. The system is configured to, based on the measurements from the two transducers, calculate if the object is within a predetermined distance from the keyboard and in that case activate a predetermined functionality of the keyboard.

The present invention relates to a keyboard being capable of sensing the proximity of the user hands and controlling the functionality of the keyboard and connected keyboard.

At the present computers and similar devices are becoming advanced, and also complex including numerous different units and processes for giving the user an optimal and easy experience with the device, such as lighting up the keyboard in order to make use in limited light more convenient. These processes and units, however, require power and also adds to the complexity and price of the device, as well as the chance of failure. One well known solution to reduce the power consumption is the sleep modes that are configured to be activated when the computer has been inactive for a predetermined amount of time. These modes often require an action from the user, e.g. moving the mouse or touching the keyboard, sometimes requiring entering a password, or by touching a fingerprint sensor.

One example of the use of proximity sensors relative to a keyboard is described in U.S. Pat. No. 5,758,173 wherein ultrasound sensors are used to detect if the user's hands are positioned over the keyboard. A more advanced solution for proximity detection is proposed in US2013275872A1, where acoustic sensors such as microphones are configured to sense the direction of a sound source, especially a voice, and activate the device when the user is in from of the device. This, however, represents a complex, and thus power consuming, algorithm and also may require dedicated units such as microphones as not every device is provided with more than one microphone and also not the necessary microphone quality. Another example of the know art is shown in WO2011/004135, where acoustic sensors in a device is used for measuring movements and gestures, and also describes the [symbol] keyboard of a laptop to support the gesture measurements

The present invention is aimed at a simple and cost-efficient solution for activating power consuming features with a computer and/or related keyboard. This is obtained as discussed in the accompanying claims.

The present invention thus provides a control the backlight of a keyboard by detecting if hands are present on the keyboard or not. The keyboard may be related to a laptop or be a separate, wired or wireless keyboard. When one or two hands are detected above the keyboard, the backlight is turned on and when no hands are detected above the keyboard, the backlight is turned off, possibly after a predetermined time. With a separate, wireless keyboard the communication with the related computer may be to turn backlight on or off depending on the proximity of the hands.

The indicated presence may also be transmitted to the computer or an external device so as to activate related functionalities in the other devices in a communication network, as discussed in NO20211334. In the same way, if the presence of a user is no longer detected a signal may be transmitted in the communication network indicating that the user is not present, and the related functionalities as shut down or reduced in order to save power.

According to another aspect of the invention the presence detection system may be adapted to adjust the predetermined characteristics of the acoustic signal based in the detected distance to and/or movement of a nearby object, as disclosed in NO20211332. This may include increasing the rate of the measured signal based on the distance, e.g. by increasing the rate when an object is closer or is moving in the direction of the keyboard. When the keyboard is in use the presence detection may be turned off or reduced.

In a preferred solution the system initially has a low power system, e.g. using a well-known acoustic low power [symbol] system or transmitting at a low rate, indicating if a person is present. Once the user is detected a second step is activated where the proximity detection system increases the activity and/or activates other sensors being capable of detecting if the user hands are above the keyboard. If two separate transducer sets are used the first set may be deactivated as long as the hands are detected above the keyboard. When other activities are detected, for example when the device is in used, the presence detection system may be reduced again, possibly maintaining it at a level being capable of detecting and measuring hand gestures above the keyboard or at a low level confirming the presence of the user.

According to another embodiment the keyboard may include analysis means being configured to analyze the background signals and choose the frequency and sampling rate based on the signals from the environment, as discussed in NO20220394.

The value is that the user does not need to find and press a random key to light up the keyboard to start typing while in a dark room. It removes the predefined timeout to turn off the backlight, creating a simple and calm experience that reflects the intention of the user.

The same functionality can be used to toggle full screen mode of specific applications where all or parts of the UI is shown/hidden. Examples are video playback, reading mode in a word processor or presentation software.

The invention may also provide more precise measurements of the hand movements so that the hands-on-keyboard gesture could be used to turn on the facial recognition camera for login when the computer is locked.

The simplest embodiment is that only the gesture of hands keyboard are recognized without detecting if hands are [symbol] retracting from the keyboard.

The present invention will be described more in detail below when referring to the accompanying drawings, illustrating the invention by way of examples.

FIG. 1 illustrates a computer with sensors according to the invention.

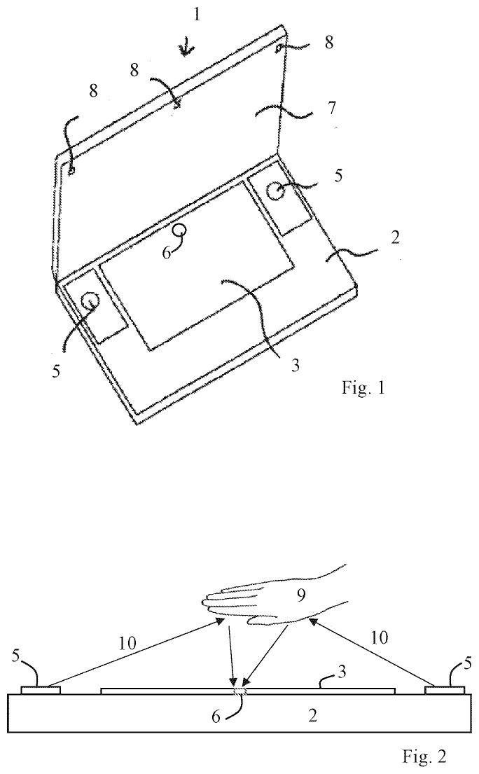

FIG. 2 illustrates the measurement above the keyboard.

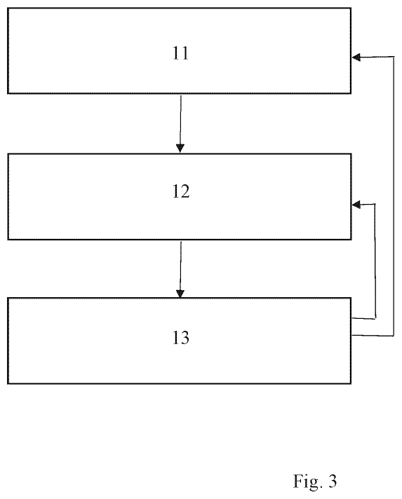

FIG. 3 illustrates the process performed by the system according to the invention.

FIG. 1 illustrates a laptop computer 1 with a body part 2 including a keyboard 3. The laptop also includes transducer units 4, in the figure being constituted by two transmitters, such as speakers 5, and one receiver, such as a microphone 6 positioned between the transmitters. The laptop also has additional sensors 8 which may be used as proximity sensors.

The speakers or microphones may be constituted by standard units of a type allowing use outside the audible range, preferably in the ultrasound range in the 20-25 kHz range. It is also possible to use transducers being suitable for both transmitting and receiving ultrasound signals in which case the microphone 6 may be omitted.

In the drawing the microphone 6 is positioned in or behind the keyboard, but any other position in relation to the keyboard is possible as long as it is able to receive reflections form an object directly above and close to the keyboard. If available an existing microphone suitable to receive signals within the ultrasound range may be used.

In addition, in a case where the keyboard is separate from the rest of the computer, an activation signal may be transmitted to the computer or screen with the additional sensors 8 through wired or wireless communication to the keyboard initiating the close proximity detection sequence [symbol] within a predetermined distance from the keyboard.

In FIG. 2 the measurement is illustrated based on two speakers 5 transmitting a signal 10 which is reflected by the user's hand 9 toward the receiver 6 positioned in or close to the keyboard. In this cased the proximity may be defined as a propagation time for the signal from transmitter to receiver, the propagation time being more than the direct propagation from the transmitter to the receiver and less than a predetermined limit defining how close the hands should be to the keyboard. This predetermined height can be set by the user. In addition, the difference between the propagation times from each of the speakers 5 to the receiver 6 must be less than a predetermined limit so as to ensure that the hand is above the keyboard. This could be achieved using a number of transducers being configured to measure the distance to the hands or person by analyzing the distances between the reflecting object and each transducer. In addition or as an alternative, the signals may be time stamped or encoded, e.g. with different frequency and/or amplitude profiles so that the receiver is able to differentiate between them to measure the separate distances. This way it is also possible to transmit and receive the signals simultaneously. The distance measuring rate may be chosen according to the device and situation. If the transducers are configured to measure movements such as gestures over the keyboard the measuring rate may be set higher than of the system is set to simply confirm that the hands are still above the keyboard. The measuring sequence may be completely turned off as long as the keyboard and/or computer is in use.

Other sensor configurations may be contemplated, such as omitting the microphone 6 and using the first transducer 5 as both transmitters and receivers, thus both measuring the distance from the transducer to the hand and when measuring similar distances differing less than the size of the keyboard indicating that the hand is above the keyboard. Another option is to use one transducer in the position of the microphone 6 both as transmitter and receiver, where the centered position may provide a good [symbol] the hands is above the keyboard if the measured distance of the keyboard. Yet another possibility is using one transmitter and one receiver on each side of the keyboard, defining the presence of a hand as the receipt of a signal having a propagation time more than the direct propagation across the keyboard but less than a predetermined limit corresponding to the presence of a hand at a certain distance from the keyboard. Another possibility is to use a number of sensors in different locations on the keyboard improving the capability of finding the position of the hand or hands above the keyboard and possibly also to detect recognizable gestures above the keyboard. Thus, adding the functionality of communicating to the keyboard or related computer without touching the keyboard.

As discussed above the present invention is especially related to the activation of predetermined functions related to the keyboard, specifically the back illumination of the keyboard. The functionalities may also include measuring movements of the hand above the keyboard, e.g. as discussed in WO2011/004135, which is incorporated here by way of reference, being able to detect and recognize gestures made by the hand above the keyboard. This may also include the additional sensor 8 (FIG. 1), biometric measurements such as facial recognition using a camera, activating a voice recognition or a fingerprint sensor in the device connected to the keyboard or in the keyboard.

In a preferred embodiment it is also possible to perform the activation as a two-step process. First detecting the proximity of a person, object etc e.g. using first transducer set using a single signal emission and reception so as to provide a proximity detection, and then activate the second transducer set to measure if the hand is in close proximity within a predetermined distance above the keyboard. In order to save power, if the first and second set includes different transducers the transducers only contributing in the first transducer set may be deactivated or lower the activity as long as the second set confirms the user activity in relation to the keyboard and/or the computer indicates that it is in use.

In another alternative the process may thus include a low [symbol] deciding if a user is present at all, then increasing the activity of the sensors, e.g. the position sampling rate and/or number of sensors, when the proximity has been detected so as to detect of the hands are above the keyboard, and then, when the computer or device is in active use, e.g. through the keyboard, mouse, touchpad etc. the proximity detection may be paused for a predetermined time period, or sufficiently reduced so as to maintain a gesture detection capability above the keyboard or simple presence detection. The power consumption will thus be at a maximum when the user has approached and had the hands above, but not using, the keyboard. If the proximity sensors detect increased activity, such as distance variations, without corresponding keyboard activity, the activity of the transducers may be increased again. The detection or sampling rate may be adjusted in steps or continuously based on the measured distance.

More in detail, as illustrated in FIG. 3 the keyboard and other functions may be in a sleep mode while at least one transmitter is configured to emit low energy pulses and detecting reception of reflected pulses. In the first step 11 only the proximity close to the keyboard may be detected, which in the next step 12 activates one or more additional transducers e.g. being distributed relative to the keyboard and confirming that the position if the object is directly above the keyboard before activating the selected functions 13.

The keyboard backlight or other functions may be turned off by the user or after a certain time and within a chosen time window may be reactivated directly in the second step 12 without entering the sleep mode 11 first, while the sleep mode may be entered after a longer time window or be chosen by the user.

To summarize the present invention relates to a keyboard control system including at least one ultrasound transducer being configured to transmit and receive ultrasound signals, or possibly at least two ultrasound transducers positioned at a distance from each other in the keyboard, [symbol] the transducers is configured to transmit ultrasound [symbol] the transducers is configured to receive ultrasound signals and based on the transmitted and received signal provide a measure of the distance to a reflecting object relative to the transducer(s). The system is configured to, based on the measurements from the two transducers, calculate if the object is within a predetermined distance from the keyboard and activate a predetermined functionality of the keyboard when the object such as one or two hands are close to the keyboard. The sequence may be done in two steps, first using a low power, e.g. at a slow repetition rate, signal detecting the proximity of an object or user before activating the close proximity measurement detecting if the object is within the predetermined distance.

Preferably the functionality at least includes being provided with a keyboard backlight. The backlight being activated at the detected presence of an object and within a certain distance from the keyboard.

Using at least two transducers, they may include two transmitters, each transmitting identifiable ultrasound signals and at least one receiver receiving the reflected signals or, as an alternative, at least one transmitter transmitting an ultrasound signal and at least two receivers receiving the reflected signals. The system thus being configured to identify if the propagation time of the reflected signals is within predetermined limits and of the difference between the propagation times is withing predetermined limits.

According to another embodiment the at least two transducers include one transmitter and one receiver being positioned at opposite sides of the keyboard, the system being configured to identify the presence of the object based on the propagation time of the ultrasound signal.

By analyzing the signals, the system may be capable of recognizing if the object, usually the person or hands, is close to the [symbol] direction toward the object. Thus, based on the analysis of [symbol] times to and from the transducers, it is possible to detect if the object is in front of the keyboard, which would imply an intention to use it, or on the side, which would not be interpreted as an intension to use it. Thus, the predetermined distance may depend on the position relative to the keyboard.

The transducers may also be configured to measure the movement of said object, thus sensing if the user intends to use the keyboard. This could involve detecting a user moving toward the keyboard from a distance or the user moving the hands closer to the keyboard. The system may also be configured to recognize a predetermined set of movements over the keyboard, thus being able to recognize and interpret gestures performed by the user, e.g. for activating selected features or giving commends to the related computer.

The functionality may also include being configured to activate a biometric sensor, e.g. a facial recognition sensor, at the detected proximity of the object. The use of the present invention would thus involve a method for controlling a keyboard and related devices the keyboard including at least two ultrasound transducers, wherein including the steps of:
a) Emitting an ultrasound signal from a least one of said transducers and receiving with a least one of said transducers a signal reflected from an object,
b) Based on the propagation time of said signal calculating if said object is within a predetermined distance from the keyboard.
c) If said object is within said predetermined limit activating chosen functions of the keyboard and related device.

The method could include an initial step of transmitting an ultrasound signal from at least one of said transmitters and at the receipt of a reflected signal indicating the presence of an object, and thus entering [symbol] the method could be initiated by a received acoustic [symbol] device or an inertia measurement in the keyboard or related device indicating an activity in relation to them.

The method may also include the steps of, at the detection of an object in the proximity, increasing the number of transducers used, the measuring rate and/or the amplitude of the ultrasound signal. It is also possible to, at the detection of use of the keyboard or related devices, reducing the number transducers, measuring rate and/or amplitude of the ultrasound signal.

1. A keyboard Keyboard control system comprising including at least one ultrasound transducer positioned in a keyboard, the at least one ultrasound transducer being adapted to transmit ultrasound signals, and being adapted to receive ultrasound signals, and provide a measure of distance to a reflecting object relative to the at least one ultrasound transducer transducers, the keyboard control system being configured to, based on the measurements from the at least one ultrasound transducer two transducers, calculate if the object is within a predetermined distance from the keyboard and in which case activate a predetermined functionality of the keyboard.

2. The keyboard control system System according to claim 1, wherein the at least one ultrasound transducer includes at least one transmitter and at least one receiver.

3. The keyboard control system System according to claim 1, wherein the keyboard is provided with a keyboard backlight, the backlight being activated at the detected presence of an object over the keyboard.

4. The keyboard control system System according to claim 1, wherein the at least one ultrasound transducer comprises at least two ultrasound transducers that each include two transmitters, each transmitting identifiable ultrasound signals and at least one receiver receiving the reflected signals, the keyboard control system being adapted to identify if a propagation time of the reflected signals is within predetermined limits and of a difference between the propagation times is withing within predetermined limits.

5. The keyboard control system System according to claim 1, wherein the at least one ultrasound transducer comprises at least two transducers that each include at least one transmitter transmitting an ultrasound signal and at least two receivers receiving reflected signals, the keyboard control system being adapted to identify if a propagation time of the reflected signals is within predetermined limits and of the if a difference between the propagation times is withing within predetermined limits.

6. The keyboard control system System according to claim 1, wherein the at least one ultrasound transducer comprises at least two transducers that each include one transmitter and one receiver being positioned at opposite sides of the keyboard, the keyboard control system being configured to identify presence of the object based on a propagation time of the ultrasound signal.

7. The keyboard control system System according to claim 1, wherein the at least one transducer is transducers are configured to measure the movement of the object.

8. The keyboard control system System according to claim 7, the keyboard control system being configured to recognize a predetermined set of movements over the keyboard, thus being able to recognize and interpret gestures performed by a user, e.g. for activating selected features or giving commends to the related computer.

9. The keyboard control system System according to claim 1, the keyboard control system being configured to activate a biometric sensor, e.g. a facial recognition sensor, at the detected proximity of the object.

10. The keyboard control system System according to claim 1, being configured to, in a first detection sequence configured to use low power signals detecting the presence of an object or person, and at the detected presence activate the distance measurements.

11. A method Method for controlling a keyboard and related devices, the keyboard including at least one ultrasound transducer, the method comprising: wherein including the steps of:
a) Emitting an ultrasound signal from at least one of the at least one transducer said transducers and receiving with a least one of the at least one transducer said transducers a signal reflected from an object;
b) Based on a propagation time of the signal calculating if [said] the object is within a predetermined distance from the keyboard; and
c) If the object is within the predetermined limit activating chosen functions of the keyboard and related device.

12. The method Method according to claim 11, comprising including an initial step of transmitting an ultrasound signal from at least one of the transmitters and at the receipt of a reflected signal indicating an object in the proximity of the keyboard entering step a).

13. The method Method according to claim 11, comprising including a step d) after step c), including the detection of a use of the keyboard, reducing the ultrasound emission.

14. The keyboard control system according to claim 8, wherein the gestures are for activating selected features or giving commends to the related computer.

15. The keyboard control system according to claim 9, wherein the biometric sensor is a facial recognition sensor.
